(19) United States
(12) Patent Application Publication
(10) Pub. No.: US 2020/0339137 A1
(43) Pub. Date: Oct. 29, 2020

(54) CONTROL DEVICE FOR MOTOR VEHICLE, MOTOR VEHICLE, ASSOCIATED CONTROL METHOD AND COMPUTER PROGRAM

(71) Applicant: TRANSDEV GROUP, ISSY LES MOULINEAUX (FR)

(72) Inventor: Thomas DARNAUD, VERSAILLES (FR)

(21) Appl. No.: 16/857,017

(22) Filed: Apr. 23, 2020

(30) Foreign Application Priority Data
Apr. 25, 2019 (FR) 19 04368

(51) Int. Cl. B60W 50/00; B60W 40/08; B60W 60/00; B60W 10/30; B60W 50/14

(52) U.S. Cl. CPC B60W 50/0098; B60W 40/08; B60W 60/00; B60W 10/30; B60W 2420/54; B60W 2540/049; B60W 2540/221; B60W 2420/42; B60W 50/14

(57) ABSTRACT

A control device is intended to be embedded in a motor vehicle including a passenger compartment and at least one passenger service equipment item. The control device is provided to be coupled to each passenger service equipment item and includes a detection module configured to detect at least one passenger in the passenger compartment, a classification module configured to classify the detected passenger in at least one passenger category, and a generating module configured to generate, as a function at least of said passenger category, a command of the at least one passenger service equipment item.

### FIELD OF THE INVENTION

The present invention relates to a control device for a motor vehicle, as well as a motor vehicle including such a control device. The present invention also relates to a method for controlling a motor vehicle as well as a computer program including software instructions implementing such a method.

### BACKGROUND OF THE INVENTION

Many vehicles include a passenger compartment intended to receive one or several passengers. These passenger compartments include many equipment items intended to render services to the passengers, that is to say, to perform actions that do not relate to the driving of the vehicle, but participate in improving the experience of the passengers present in the vehicle. These passenger service equipment items for example includes seats, display screens, speakers playing music or audio announcements, or devices regulating the temperature in the passenger compartment.

Many parameters of these passenger service equipment items are adjustable, for example the audio volume, the broadcast messages, or the setpoint value around which the temperature is adjusted. These adjustments are frequently centralized via a single control module that allows a user, in particular the driver of the vehicle or a remote supervisor of the fleet of vehicles, to change these parameters through a single interface.

However, the relevance of the adjustment of the service equipment to the passengers can be further improved. In particular, the adjustment of these equipment items by the driver adds an additional workload, and fine adjustments are therefore not compatible with the workload imposed by the driving. When the adjustment of the equipment items is done remotely by a supervisor of the vehicle, this supervisor is responsible for a large number of vehicles and therefore cannot intervene frequently for fine adjustments. In other cases, for example if the vehicle does not include a driver, the equipment items are only adjusted when the vehicle is at the depot, which further decreases the relevance of these adjustments, which can be unsuitable for new circumstances.

### SUMMARY OF THE INVENTION

The aim of the invention is to propose a control device making it possible to further improve the relevance of the adjustment of the parameters of the passenger service equipment items of the vehicle.

To that end, proposed is a control device intended to be embedded in a motor vehicle, in particular in an autonomous motor vehicle, the motor vehicle including a passenger compartment able to receive at least one passenger and at least one service equipment item for passengers of the passenger compartment, the control device being provided to be coupled to each passenger service equipment item and including:
a detection module configured to detect at least one passenger of the passenger compartment,
a classification module configured to classify the detected passenger in at least one passenger category, in particular among a set of predetermined passenger categories, and
a generating module configured to generate, as a function at least of said passenger category, a command of the at least one passenger service equipment item.

According to specific embodiments, the control device comprises one or more of the following features, considered alone or according to any technically possible combinations:
the detection module is configured to detect a plurality of passengers of the passenger compartment, the classification module being configured to classify each detected passenger in at least one corresponding passenger category, the generating module being configured to compute the command as a function of each detected category.
the generating module is configured to compute, for each passenger category, a number of passengers categorized in the category, to determine a majority passenger category from the computed numbers of passengers and to generate the command as a function of the majority passenger category.
the generating module is configured to sequence the passenger categories associated with the detected passenger(s) according to an order relationship and to generate the command as a function of the order of the passenger categories associated with the detected passenger(s).
each passenger category is chosen from the group consisting of:
   children,
   the elderly,
   persons speaking a predetermined language,
   persons having a predetermined morphology,
   persons with reduced mobility,
   the blind and persons with low vision,
   persons accompanied by luggage,
   persons having a predetermined posture,
   men, and
   women.
the detection module includes at least one sensor chosen from the group consisting of: an image sensor, a presence sensor, a sound sensor, an infrared sensor and a temperature sensor.
at least one sensor is an image sensor, in particular a stereoscopic image sensor, the classification module being configured to classify the passenger by determining a height of the passenger from image(s) coming from the image sensor.
at least one sensor is a sound sensor, the classification module being configured to identify a language spoken by at least one passenger, the generating module being configured to send the passenger service equipment item a command to transmit information to the passenger (49) in the identified language.

Also proposed is a motor vehicle, in particular an autonomous motor vehicle, the motor vehicle including the passenger compartment able to receive at least one passenger and at least one service equipment item for the passenger(s) received in the passenger compartment, the motor vehicle including a control device as previously described, the control device being coupled to each passenger service equipment item.

According to one specific embodiment, the passenger service equipment item is chosen from the group consisting of:
an equipment item for regulating the temperature of the passenger compartment,
a display device,
an acoustic device,
a seat,
a door of the passenger compartment,
a smell generating device,
a control member able to be actuated by a passenger,
a window of the passenger compartment, and
a power outlet.

Also proposed is a control method of a motor vehicle (10), in particular of an autonomous motor vehicle, the motor vehicle including the passenger compartment able to receive at least one passenger, at least one service equipment item for the passenger(s) of the passenger compartment and a control device including an electronic detection module, an electronic classification module and an electronic generating module, the method comprising the following steps:
detecting at least one passenger of the passenger compartment via the detection module,
classifying the detected passenger in at least one passenger category, in particular among a set of predetermined passenger categories, via the classification module,
generating, via the generating module, a command of the passenger service equipment item, as a function at least of the identified passenger category, and
sending the command to the passenger service equipment item via the generating module.

Also proposed is a computer program including software instructions which, when executed by a computer, carry out a method as previously described.

### BRIEF DESCRIPTION OF THE DRAWINGS

Features and advantages of the invention will appear more clearly upon reading the following description, provided solely as a non-limiting example, and done in reference to the appended drawings, in which:

FIG. 1 is a schematic illustration of a vehicle including a control device according to the invention,

FIG. 2 is a schematic illustration of the control device of FIG. 1, and

FIG. 3 is a flowchart of the steps of a control method of the vehicle of FIG. 1.

### DETAILED DESCRIPTION OF PREFERRED EMBODIMENTS

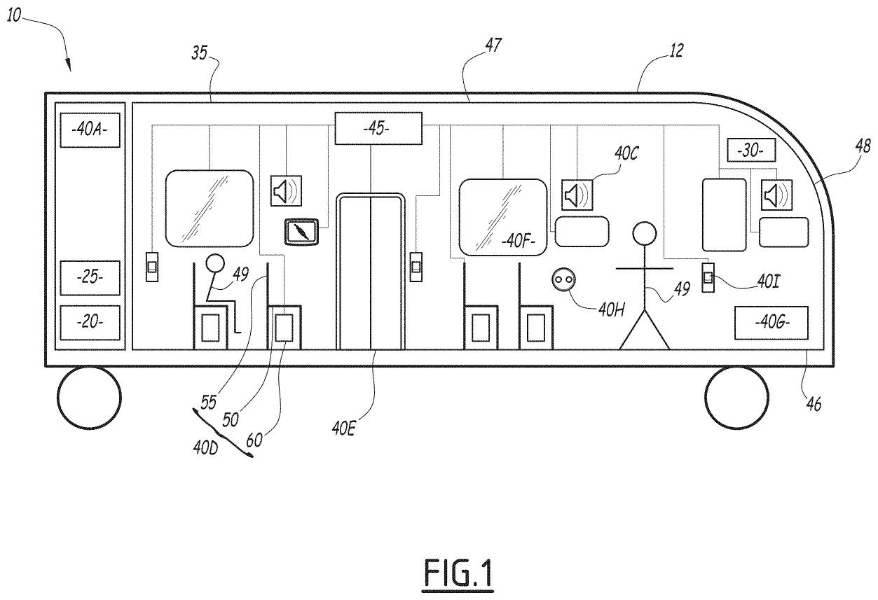

A motor vehicle 10 is shown schematically in FIG. 1.

The vehicle 10 is for example a motor vehicle, in particular a bus. However, other types of motor vehicles can be considered, for example individual vehicles such as a car.

As shown in FIG. 1, each vehicle 10 comprises, in a known manner, a body 12, wheels, a motor 20 mechanically coupled via a transmission chain (not shown) to the wheels for the driving of said wheels in rotation about their axis, a steering system (not shown), suitable for acting on the wheels of the vehicle 10 so as to modify the orientation of its trajectory, and a braking system (not shown), suitable for exerting a braking force on the wheels of the vehicle 10.

Each motor vehicle 10 is typically made up of a traction and/or electric propulsion vehicle. To that end, the motor 20 is made up of an electric motor, and the vehicle 10 comprises an electric battery (not shown) electrically connected to the motor 20 to supply the motor 20 with electricity.

Each motor vehicle 10 is for example an autonomous vehicle. To that end, the motor vehicle 10 comprises an electronic autonomous driving device 25 suitable for controlling the vehicle autonomously by receiving information on the environment of the vehicle 10 by means of at least one sensor 30, also called environment sensor, and by acting on the motor 20, the steering system and the braking system, so as to modify the speed, the acceleration and the trajectory of the vehicle 10 in response to the received information. Each environment sensor 30 is for example a camera, a temperature sensor, a pressure sensor, a humidity sensor or a lidar.

Each autonomous motor vehicle 10 preferably has a level of automation greater than or equal to 3 on the scale of the Organisation Internationale des Constructeurs Automobiles (OICA). The level of automation is then equal to 3, that is to say, a conditional automation, or equal to 4, that is to say, a high automation, or equal to 5, that is to say, a full automation.

According to the OICA scale, level 3 for conditional automation corresponds to a level for which the driver does not need to perform continuous monitoring of the driving environment, while still having to be able to take back control of the autonomous motor vehicle 10. According to this level 3, a system for managing the autonomous driving, on board the autonomous motor vehicle 10, then performs the longitudinal and lateral driving in a defined usage case and is capable of recognizing its performance limits to then ask the driver to take back dynamic driving with a sufficient time margin.

The high level of automation 4 then corresponds to a level for which the driver is not required in a defined usage case. According to this level 4, the system for managing the autonomous driving, on board the autonomous motor vehicle 12, then performs the dynamic longitudinal and lateral driving in all situations in this defined usage case.

The full automation level 5 lastly corresponds to a level for which the system for managing the autonomous driving, on board the autonomous motor vehicle 10, performs the dynamic lateral and longitudinal driving in all situations encountered by the autonomous motor vehicle 10, throughout its entire journey. No driver is then required.

As shown in FIG. 1, the vehicle 10 further advantageously comprises at least one passenger compartment 35, at least one service compartment 37, at least one service equipment item 40A to 401 and at least one control device 45.

Each passenger compartment 35 is defined by the body 12. In particular, each passenger compartment 35 is defined by a floor 46, a ceiling 47 and side walls 48 arranged in the body 12.

Each passenger compartment 35 is able to receive at least one passenger 49, for example a plurality of passengers 49.

According to the example shown in FIG. 1, the vehicle 10 includes a single passenger compartment 35 that occupies the majority of the space defined by the body 12. In a variant, the vehicle 10 includes a plurality of passenger compartments 35 that are separate from one another.

Each service compartment 37 is a separate compartment from the passenger compartment(s) 35 of the vehicle 10. In particular, each service compartment 37 is configured to prevent the passenger(s) 49 from accessing the service compartment 37 when the vehicle 10 is in use.

Each service compartment 37 receives at least one equipment item of the vehicle 10, for example the engine 20, the steering system or the autonomous driving device 35.

In FIG. 1, a single service compartment 37 is shown, this service compartment being positioned behind the passenger compartment 35. It should be noted that the number of service compartments 37 as well as their positioning in the vehicle 10 may vary.

Each service equipment item 40A to 401 is a passenger service equipment item 49 of a corresponding passenger compartment 35. For example, at least one passenger service equipment item 40A to 401 is an equipment item usable by at least one passenger 49 of the passenger compartment 35. In a variant, at least one service equipment item 40A to 401 is an equipment item provided to interact with a passenger 49 of the passenger compartment 35.

According to the example of FIG. 1, the vehicle 10 includes a plurality of passenger service equipment items 40A to 401.

Each passenger service equipment item 40A to 401 is for example chosen from the group consisting of:
an equipment item for regulating the temperature 40A,
a display device 40B,
an acoustic device 40C,
a seat 40D,
a door 40E of a passenger compartment 35,
a window 40F of a passenger compartment 35,
a smell generating device 40G,
a power outlet 40H,
a bulb, and
a control member 401.

It should be noted that other types of passenger service equipment items may also be considered.

Each temperature regulating equipment item 40A is configured to modify the temperature of the corresponding passenger compartment 35. In particular, each temperature regulating equipment item 40A is able to regulate the temperature around a setpoint value.

According to one embodiment, each temperature regulating equipment item 40A is able to regulate the temperature of a specific zone of the passenger compartment 35 around a setpoint value.

Each temperature regulating equipment item 40A is, for example, an air conditioner, or a heating equipment item.

Each temperature regulating equipment item 40A for example comprises at least one sensor able to measure values of the temperature of the corresponding passenger compartment 35 and a regulating device able to inject a stream of hot air or cold air into the passenger compartment 35 as a function of the measured temperature values.

Each temperature regulating equipment item 40A is, for example, at least partially received in a corresponding service compartment 37.

Each display device 40B is configured to display at least one visual information item intended for one or more passenger(s) 49 of the corresponding passenger compartment 35.

For example, each display device 40B includes a screen able to display images or text.

Each display device 40B is, for example, attached to an inner wall of the corresponding passenger compartment 35, for example hung from the ceiling 47 or fastened to a side wall 48 of the passenger compartment 35. In a variant, at least one display device 40B is attached to a seat 40D, for example to the back side of a seatback of the seat 40D.

Each acoustic device 40C is configured to emit a sound intended for at least one passenger 49 of the passenger compartment 35. For example, each acoustic device 40C is configured to emit sound information, for example information relative to the movement of the vehicle 10, or music, intended for at least one passenger 49 of the passenger compartment 35.

A speaker is one example of an acoustic device 40C.

Each acoustic device 40C is, for example, attached to an inner wall of the corresponding passenger compartment 35, for example hung from the ceiling 47 or fastened to a side wall 48 of the passenger compartment 35. In a variant, at least one acoustic device 40C is attached to a seat 40D, for example to the back side of a seatback of the seat 40D.

According to one embodiment, at least one acoustic device 40C is secured to a corresponding display device 40B. For example, the acoustic device 40C and the display device 40B are part of a multimedia device, such as a tablet. In particular, the multimedia device is configured to be controllable by a passenger 49 of the corresponding passenger compartment 35, in particular to display information or emit sounds selected by the passenger 49.

In FIG. 1, six seats 40D are shown. However, the number of seats 40D may vary.

Each seat 40D is configured to allow a passenger 35 of the corresponding passenger compartment 35 to sit on the seat 40D.

Each seat 40D includes at least one seat bottom 50 able to support the passenger 49, and optionally, a backrest 55 provided to allow the passenger 49 to rest his back against the backrest.

In FIG. 1, each seat bottom 50 is planar and horizontal. However, the orientation and the shape of the seat bottoms 50 can vary from one embodiment to another, as well as the shape and the orientation of the backrest 55.

Each seat 40 further comprises at least one actuator 60, in particular a set of actuators 60, that are configured to modify parameters of the seat 40D. In FIG. 1, a single actuator 60 is shown symbolically.

For example, at least one actuator 60 is configured to modify the distance between the floor 46 and the seat bottom 50, for example to move the seat bottom 50 in translation vertically relative to the floor 46. Optionally, at least one actuator 60 is configured to pivot the backrest 55 relative to the seat bottom 50, or to translate the backrest 55 relative to the seat bottom 50.

According to one variant, at least one seat 40D is a jumpseat. A jumpseat is a seat 40D whereof the seat bottom 50 can pivot between a low position and a high position about a horizontal axis. In the low position, the seat bottom 50 is substantially horizontal and able to support a passenger 49 seated on the seat bottom 50. In the high position, the seat bottom 50 is substantially vertical and prevents a passenger from sitting on the seat bottom 50. In this case, the actuator 60 is configured to move the seat bottom 50 between its high position and its low position, and/or to lock the seat bottom 50 in one of these two positions. When the seat bottom 50 is locked in one of its high and low positions, the seat bottom 50 prevents a passenger 49 from moving the seat bottom 50 into the other position among its high and low positions.

Optionally, at least one seat 40D is a heating seat, the seat bottom 50 and/or the backrest 55 of which includes heating elements. According to another variant, the seat 40D comprises movable members able to massage part of the body of a passenger 49 seated on the seat 40D, in particular to massage the back of the passenger 49.

Each door 40E is configured to allow a passenger 49 to enter the corresponding passenger compartment 35 or to leave the corresponding passenger compartment 35. For example, at least one door 40E, in particular each door 40E, is configured to allow the passage of passengers 49 between the passenger compartment 35 and the outside of the vehicle 10. In a variant, at least one door 40E is configured to allow the passage of passengers 49 between two separate passenger compartments 35 of the vehicle 10.

Each door 40E for example includes an actuator, not shown, able to lock the door 40E, that is to say, to keep the door 40E in a configuration in which the door 40E prevents the passage of passengers 49 through the door 40E. In particular, the actuator is provided to keep a panel of the door 40E in a position in which the door panel closes off an opening of the body 12.

Each window 40F is configured to allow a passenger 49 to observe the outside of the vehicle 10 from the corresponding passenger compartment 35. For example, each window 40F includes a panel that is transparent to the visible radiation arranged in an opening of the body. The panel is in particular movable between a closing position in which the panel completely closes the corresponding opening and an open position in which the opening is at least partially freed.

Each window 40F is for example arranged in a side wall 48 of the body. In a variant or additionally, at least one window 40F is a sunroof arranged in a roof of the body 12.

Each window 40F for example includes an actuator, not shown, able to lock the window 40F, that is to say, to keep the panel of the window 40F in the closed position. In particular, the actuator is able to prevent a passenger 49 from moving the panel of the window 40F when the window 40F is locked.

As an optional addition, the window for example comprises a concealing device able to conceal the window 40F. The concealing device is for example a curtain or a moving flap, or a glass of the panel of the window 40F, the opaqueness of which is for example variable under the influence of an electric voltage.

Each smell generating device 40G is configured to modify a smell of the passenger compartment 35, in particular to inject a fragrance into the passenger compartment 35.

The smell generating device 40G is for example a sprayer capable of spraying a fragrance, or a fragrance diffuser, in particular using a stream of air able to transport the fragrance evaporating from the diffuser.

Each power outlet 40H is provided to supply electricity to a device removably attached to the power outlet 40H. For example, each power outlet 40H is a wall outlet carried by a wall, in particular a side wall 48 of the body 12.

Each control member 401 is a member able to be actuated by a passenger 49 in order to send an instruction to a device of the vehicle 10. In particular, the control member 401 is configured to generate an instruction signal intended for another device of the vehicle 10 when the control member 401 is actuated by passenger 49.

According to one embodiment, at least one control member 401 is able to control the execution of an action by another passenger service equipment item. In this case, the instruction signal is sent to another passenger 49 service equipment item 40A, 40B, 40C, 40D, 40E, 40F, 40G or 40H of the vehicle 10.

For example, the control member 401 is able to control an actuator of a seat 40D, a door 40E or a window 40F. In a variant, the control member 401 is configured to control the display of a specific information item by a display device 40B or the sending of a sound or specific sound information by an acoustic device 40C. According to another variant, the control member 401 is configured to modify the setpoint temperature of the temperature regulating equipment item 40A.

According to another variant, the control member 401 is configured to send, to the autonomous driving electronic device 25, an instruction signal requesting stopping of the vehicle 10, in particular stopping of the vehicle 10 in a predetermined location of the traffic lanes in which the vehicle 10 is traveling.

An activated operating mode and a deactivated operating mode are defined for each control member 401. When the control member 401 is in the activated mode, the control member sends an instruction signal when the control member 401 is actuated by a passenger. On the contrary, when the control member 401 is in the deactivated mode, the control member 401 does not send an instruction signal when the control member 401 is actuated by a passenger.

The control device 45 includes a detection module 65, a classification module 70, a generating module 75 and an information processing unit 80.

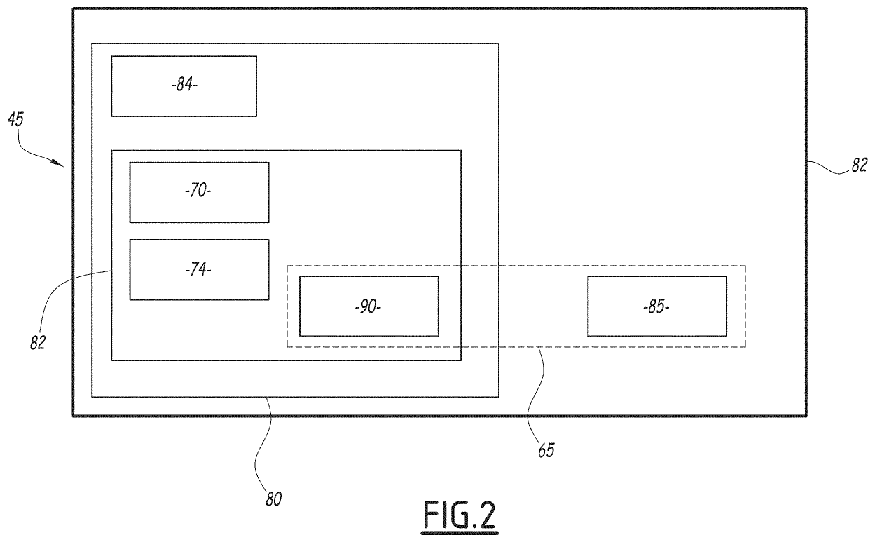

According to the embodiment shown in FIG. 2, the control device 45 further includes a single housing 82 delimiting a receiving volume of the detection module 65, the classification module 70, the generating module 75 and the information processing unit 80. In a variant, the detection 65, classification 70 and generating 75 modules are able to be distributed in two or more separate housings.

The control device 45 is coupled to each passenger service equipment item 40A to 401. For example, the control device 45 is coupled to each passenger service equipment item 40A to 401 for a wired connection capable of sending information between the control device 45 and the passenger service equipment item 40A to 401 in the form of electrical signals. In a variant, the control device 45 is coupled to at least one passenger service equipment item 40A to 401 via a radiofrequency datalink in which the information items are transmitted in the form of electromagnetic waves having a frequency of less than or equal to 300 gigahertz (GHz).

The detection module 65 is configured to detect at least one passenger 49 received in one of the passenger compartments 35. For example, the detection module 65 is configured to detect a plurality of passengers 49 received in one of the passenger compartments 35, in particular each passenger 49 received in the considered passenger compartment 35.

The detection module 65 for example includes at least a sensor 85 and an identification module 90.

Each sensor 85 is for example received in the housing 82. However, embodiments in which at least one sensor 85 is positioned outside the housing 82 may also be considered.

Each sensor 85 is configured to measure values of at least one property and to send the measured values to the identification module 90.

Each sensor 85 is, for example, chosen from the group consisting of: an image sensor, a presence sensor, a sound sensor, an infrared sensor and a temperature sensor.

An imager including a set of detection elements or pixels distributed in the form of a regular grid is an example of an imager.

In a variant, when a sensor is an image sensor, the sensor is a stereoscopic sensor. A stereoscopic sensor is configured to generate a three-dimensional depiction of a scene from two or more images taken from different angles. A stereoscopic sensor for example comprises two imagers separated by a known distance, the knowledge of this distance then allowing the sensor to generate the three-dimensional depiction from two images via the knowledge of the relative positioning of the imagers.

The identification module 90 is configured to detect at least one passenger 49, for example a plurality of passengers 49, in particular each passenger 49 received in the passenger compartment 35 in question, from values measured by the sensor(s) 85.

The classification module 70 is configured to classify each detected passenger 49 in at least one passenger category 49. In particular, the classification module 70 is configured to classify each passenger 49 in a plurality of passenger categories 49.

Each passenger category 49 is in particular chosen from a set of predetermined passenger categories. The classification module 70 is for example configured to classify each passenger 49 into each passenger category 49, from the set of passenger categories 49, that applies to the considered passenger 49.

The set of predetermined passenger categories 49 for example comprises the group consisting of:
children,
the elderly,
persons speaking a predetermined language,
persons having a predetermined morphology,
persons with reduced mobility,
the blind and persons with low vision,
persons accompanied by luggage,
persons having a predetermined posture,
persons accompanied by pets,
men, and
women.

A child is associated, inter alia, with a height below or equal to a predetermined threshold.

For example, the classification module 70 is configured to determine a height of the passenger 49 from at least one image coming from the image sensor 85, in particular if the image sensor 85 is a stereoscopic sensor 85, and to classify the passenger 49 as a function of the determined height. The classification module 70 is in particular configured to classify the passenger 49 in the “child” category when the height is below the predetermined threshold.

In addition, the classification module 70 is configured to classify the passenger 49 in the child category as a function of at least one image of the face of the passenger 49, a voice of the passenger 49, or a behavior of the passenger 49. The classification of the passenger from an image of the face for example comprises detecting specific points of the face.

In particular, the detection module 70 is configured to classify the passenger 49 in the child category as a function of at least two criteria among a height of the passenger 49, an image of the face of the passenger 49, a voice of the passenger 49 and/or a behavior of the passenger 49.

An elderly person is in particular identified from one or several image(s) of the face, in particular by detection of specific points of the face, or from the detection of an accessory such as a cane, or from a recording of the voice of the passenger 49.

The classification module 70 is configured to identify a language spoken by at least one passenger 49 from values coming from a sound sensor 85, and to classify the passenger in the category of people speaking said language.

In one advantageous embodiment, when at least one of the sensors 85 in the vehicle 10 is an image sensor, the classification module 70 is configured to classify the passenger(s) 49 by processing of image(s) coming from the image sensor associated with a machine learning method.

The machine learning method is for example based on a model using a statistical approach in order to make it possible to improve the performance of this method to resolve tasks without being explicitly programmed for each of these tasks. The machine learning includes two phases. The first phase consists of defining a model from data present in a database, called observations. The estimation of the model in particular consists of recognizing the presence of one or several objects in an image. This so-called learning phase is generally carried out before the practical use of the model. The second phase corresponds to the use of the model: the model being defined, new images can then be submitted to the model in order to obtain the object(s) detected in said images.

In particular, the machine learning method is able to detect objects associated with the passenger 49 and characteristics of a category of the passenger 49, such as a cane or a wheelchair associated with reduced mobility of the passenger 49.

The machine learning model for example includes the implementation of a neural network. A neural network is generally made up of a series of layers, each of which takes its inputs from the outputs of the previous one. Each layer is made up of a plurality of neurons, taking their inputs from the neurons of the previous layer. Each synapse between neurons has an associated synaptic weight, such that the inputs received by a neuron are multiplied by this weight, and then said neuron is added. The neural network is optimized owing to the adjustments of the different synaptic weights during the learning phase as a function of the images present in the initial database.

The generating module 75 is configured to generate a command of at least one passenger 49 service equipment item 40A to 401 as a function of at least one category of passengers 49 determined by the classification module 70. The generating module 75 is further configured to send the command to the passenger service equipment item 40A to 401.

Each command is for example a command to modify a state of the passenger service equipment item 40A to 401.

The command is, for example, computed as a function of each category detected for all of the passengers 49 of a same passenger compartment 35, or for all of the passengers 49 of the vehicle 10.

The generating module 75 is further configured to sequence the passenger categories associated with the detected passengers 49 according to an order relationship, and to generate the command as a function of the order of the passenger categories. For example, the set of predetermined passenger categories is a sequenced set, by which an order relationship is determined between the different passenger categories. In particular, the order relationship is able to determine, for each group of passenger categories chosen from the set of predetermined passenger categories, a priority passenger category relative to the other categories in the group.

The order relationship is, for example, predetermined, in which case the passenger categories are still sequenced in the same order.

The generating module 75 is for example configured in order, when several passengers 49 belonging to different passenger categories are present in a same passenger compartment, to generate the command as a function of the priority category among the passenger categories represented by the passengers 49.

In a variant or additionally, the generating module 75 is further configured to compute, for each passenger category associated with at least one passenger 49 by the classification module 70, a number of passengers 49 classified in said category. The generating module 75 is further configured to determine a majority passenger category among the passenger categories each associated with at least one passenger 49, and to generate the command as a function of the majority passenger category. The majority category is the passenger category for which the number of passengers is the highest. In this case, the order relationship between the passenger categories may vary as a function of the passengers 49 present in the vehicle 10.

According to one embodiment, each passenger service equipment item 40A to 401 is associated with a subset of categories among the predetermined passenger categories, the subset grouping together the passenger categories associated with commands that may be sent to said passenger service equipment item 40A to 401. The command is generated as a function of the majority category among the categories of the subset that are represented among the detected passenger(s) 49.

In a variant or additionally, the command is computed as a function of each detected category for a subset of passengers 49 among the set of detected passengers 49. For example, the generating module 75 is configured to determine a distance between each passenger 49 and the passenger service equipment item 40A to 401, and to generate the command for said passenger service equipment item 40A to 401 as a function of the determined distance. For example, the generating module 75 is configured to generate the command as a function of the category or categories associated with each passenger 49 for which the distance is less than or equal to a predetermined distance.

The information processing unit 80 is for example formed from a memory 82 and a processor 84 associated with the memory 82.

In the example of FIG. 2, the identification module 90, the classification module 70 and the generating module 75 are each made in the form of software, or a software component, executable by the processor 84. The memory 82 is then able to store identification software, detection software, generating software, acquisition software, location software and counting software. The processor 64 is then able to execute each piece of software.

In a variant that is not shown, the identification module 90, the classification module 70 and the generating module 75 are each made in the form of a programmable logic component, such as an FPGA (Field Programmable Gate Array), or in the form of a dedicated integrated circuit, such as an ASIC (Application-Specific Integrated Circuit).

When the control device 45 is made in the form of one or several software programs, i.e., in the form of a computer program, it is further able to be stored on a medium, not shown, readable by computer. The computer-readable medium is for example a medium suitable for storing electronic instructions and able to be coupled with a bus of a computer system. As an example, the readable medium is an optical disc, a magnetic-optical disc, a ROM memory, a RAM memory, any type of non-volatile memory (for example, EPROM, EEPROM, FLASH, NVRAM), a magnetic card or an optical card. A computer program including software instructions is then stored on the readable medium.

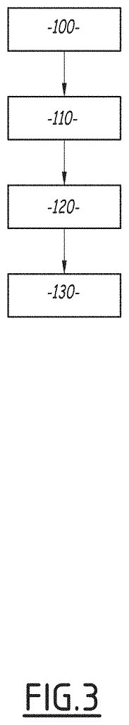

The operation of the control device 45 will now be described using FIG. 3, showing a flowchart of the steps of a method according to the invention for controlling the motor vehicle 10, the method being implemented by the electronic control device 45.

The method comprises a detection step 100, a classification step 110, a generating step 120 and a transmission step 130.

During the detection step 100, at least one passenger 49, in particular each passenger 49, present in a passenger compartment 35 of the vehicle 10 is detected by the identification module 85 from values measured by the sensor(s) 90. Advantageously, the identification module 85 detects the passenger(s) 49 from values measured by at least two separate sensors 90.

During the classification step 110, the classification module 70 classifies each detected passenger 49 in one or several passenger categories. For example, the classification module 70 classifies the passenger(s) as a function of values measured by at least two separate sensors 85.

For example, a passenger 49 is classified in the category of children as a function of at least an image of the face of the passenger 49 and/or a height of the passenger 49 determined from image(s) supplied by an image sensor 85 and/or from a voice of the passenger 90 identified by a sound sensor 85.

A passenger 49 is for example identified in the category of elderly persons from images of the face of the passenger 49. Furthermore, a passenger 49 is classified in the category of persons speaking a predetermined language as a function of values measured by a sound sensor 85.

The classification step 110 is followed by the generating step 120. During this generating step 120, the generating module 75 generates at least one command intended for at least one of the passenger service equipment items 40A to 401.

The command is generated as a function of at least one category in which at least one passenger 49 of interest is classified. “Passenger of interest” 49 refers to a passenger taken into account by the generating module 75 in order to generate the command.

According to one embodiment, the command is generated as a function of each category associated with at least one detected passenger 49, in which case each detected passenger 49 is a passenger of interest.

In a variant, the command is generated as a function of each category associated with at least one passenger 49 of a subset of the set of detected passengers 49. In this case, each passenger 49 of the subset is a passenger of interest, while each passenger 49 who does not belong to the subset is not a passenger of interest.

The passengers of interest 49 are for example the passenger(s) 49 detected in a predetermined zone of the passenger compartment 35 or of one of the passenger compartments 35. The predetermined zone is in particular a zone comprising each passenger 49 located at a distance below or equal to a predetermined distance threshold of the passenger service equipment item 40A to 401 for which the command is intended.

The command is for example generated as a function of a passenger category identified as having priority among the set of passenger categories 49 associated by the classification module 70 with the passenger(s) 49 of interest.

In a variant or in addition, the command is generated as a function of a passenger category identified as making up the majority among the passenger category or categories associated with the passenger(s) 49 of interest.

When the passenger service equipment item is a temperature regulating equipment item 40A, the command is, for example, a command setting a setpoint temperature value of the temperature regulating equipment item 40A. In a variant, the command is a command to deactivate the temperature regulating equipment item 40A.

For example, when the generating device 75 determines that a majority of passengers in the passenger compartment 35 (respectively in a specific zone of the passenger compartment 35) are women, the generating device 75 generates a command setting the setpoint temperature value at a first value. If, on the contrary, the generating device 75 determines that a majority of passengers in the passenger compartment 35 (respectively in a specific zone of the passenger compartment 35) are women, the generating device 75 generates a command setting the setpoint temperature value at a second value.

The first value is strictly greater than the second value. The first value is for example between 23 degrees Celsius (° C.) and 27° C., in particular equal to 25° C. The second value is for example between 19° C. and 23° C.

When the passenger service equipment item is a display device 40B, the command is for example a command to change the language in which the information is displayed on the display device 40B. In particular, the command is a command ordering the display of the information in one or several languages that it has been determined that a passenger of interest 49 speaks.

In a variant or additionally, the command is a command to change a size of the characters displayed on the display device, in particular to increase the size if it has been determined that at least one passenger of interest 49 is an elderly person.

A command to display information suitable for a child, for example by adapting the vocabulary used, is another example of a command generated when at least one passenger of interest 49 is a child.

When the passenger service equipment item is an acoustic device 40C, the command is for example a command to change a language in which the information is emitted by the acoustic device 40C. In particular, the command is a command ordering the emission of the information in one or several languages that it has been determined that a passenger of interest 49 speaks.

A command to emit information suitable for a child, for example by adapting the vocabulary used, is another example of a command generated when at least one passenger of interest 49 is a child.

In a variant or additionally, the command is a command to emit additional information, in particular more detailed information than the information emitted in the absence of the command, when at least one passenger of interest 49 is classified in the category of the blind and persons with low vision.

According to another example, a sound level of the emitted information is modified by the command, in particular decreased, when at least one passenger of interest 49 is a child.

In a variant or additionally, the command is a command to modify the voice emitting the information, for example to modify a timbre or a level of the voice. A feminine voice is for example favored when at least one passenger of interest 49 is a child or a woman.

According to another variant, the command is a variation of music emitted by the equipment item 40C.

When the passenger service equipment item is a seat, the command is, for example, a command to lock or unlock the seat bottom 50.

For example, when a passenger of interest 49 is a person with reduced mobility, the command is a command provided to cause a movement and/or locking of the seat bottom 50 in the high position to leave room for a wheelchair. In a variant or additionally, when a passenger of interest 49 is an elderly person, the command is provided to drive a movement of the seat bottom 50 toward the low position via an actuator 60 of the seat 40D.

According to another variant, the command is a command to modify a movement of the seat bottom 50 and/or the backrest 55 when at least one passenger of interest 49 is a child. Optionally, the command further causes the deactivation of the heat and/or of the moving members of the seat 40D.

When the passenger service equipment item is a door 40E, the command is, for example, a command to lock the door 40E. A command to lock the door 40E is for example associated with the presence of a child among the passengers of interest 49.

When the passenger service equipment item is a window 40F, the command is, for example, a command to open or close the window 40F, or to lock the window 40F in its closed position. In particular, a command to close the window 40F or to lock the window 40F in its closed position is associated with the presence of a child among the passenger(s) of interest 49.

In a variant, the command is a command to conceal the window 40F, when at least one passenger of interest 49 is a child.

When the passenger service equipment item is a power outlet 40H, the command is, for example, a command to activate or deactivate the power outlet 40H.

The power outlet 40H is, for example, deactivated if a majority of passenger(s) 49 of the vehicle 10 are classified in the category of children.

When the traveler service equipment item is a bulb, the command is for example a command to change the color of the light emitted by the bulb, or a command to change the candlepower emitted by the bulb.

For example, when a passenger of interest 49 is a child, the candlepower is decreased.

Optionally, the candlepower is set, at night, to a value strictly below the candlepower value during the day.

When the traveler service equipment item is a control member 401, the command is a command to switch the control member 401 from its activated operating mode to its deactivated operating mode, or vice versa.

For example, when a passenger of interest 49 is a child, the command is intended to cause the control member 401 to switch to its deactivated operating mode.

During the transmission step 130, the command is sent by the generating module 75 to at least one passenger service equipment item 40A to 401, and implemented by each passenger service equipment item having received it.

Owing to the invention, the relevance of the adjustment of the parameters of the passenger service equipment items of the vehicle is improved, since these parameters are quickly adjusted to the passenger categories 49 represented in the vehicle 35, more finely than a driver of the vehicle 10 could do.

Furthermore, when categories of several passengers 49 are taken into account in generating the command, the relevance of the adjustments is further improved.

Generating commands as a function of a majority passenger category in particular makes it possible to account simply for the plurality of categories represented among the detected passengers 49.

Generating commands as a function of an order relationship of the categories makes it possible to improve the relevance of the sent commands, since it is possible to prioritize the commands in particular as a function of the importance of the action resulting from the command for each category. In particular, the actions relative to safety can be prioritized relative to the actions seeking to improve the comfort of the passengers 49.

The image sensors, in particular stereoscopic, are particularly suited to the detection of passengers 49 and the identification of the associated categories. The height of the passengers is one criterion allowing easy classification of the passengers in relevant categories, in particular children.

The use of a sound sensor to identify a language spoken by the passenger 49 and the command of a sending of information to this passenger in the identified language are particularly interesting to improve passenger comfort. In particular, a larger number of languages can thus be identified than if an operator were responsible for adjusting the corresponding passenger service equipment item 40B, 40C.

What is claimed is:

1. A control device intended to be embedded in a motor vehicle, the motor vehicle including a passenger compartment able to receive at least one passenger and at least one service equipment item for passengers of the passenger compartment, the control device being provided to be coupled to each passenger service equipment item and including:
a detection module configured to detect at least one passenger of the passenger compartment,
a classification module configured to classify the detected passenger in at least one passenger category, in particular among a set of predetermined passenger categories, and
a generating module configured to generate, as a function at least of said passenger category, a command of the at least one passenger service equipment item.

2. The control device according to claim 1, wherein the vehicle is an autonomous motor vehicle.

3. The control device according to claim 1, wherein the detection module is configured to detect a plurality of passengers of the passenger compartment, the classification module being configured to classify each detected passenger in at least one corresponding passenger category, the generating module being configured to compute the command as a function of each detected category.

4. The control device according to claim 3, wherein the generating module is configured to compute, for each passenger category, a number of passengers categorized in the category, to determine a majority passenger category from the computed numbers of passengers and to generate the command as a function of the majority passenger category.

5. The control device according to claim 1, wherein the generating module is configured to sequence the passenger categories associated with the detected passenger(s) according to an order relationship and to generate the command as a function of the order of the passenger categories associated with the detected passenger(s).

6. The control device according to claim 1, wherein each passenger category is selected from the group consisting of:
children,
the elderly,
persons speaking a predetermined language,
persons having a predetermined morphology,
persons with reduced mobility,
the blind and persons with low vision,
persons accompanied by luggage,
persons having a predetermined posture,
men, and
women.

7. The control device according to claim 1, wherein the detection module includes at least one sensor chosen from the group consisting of: an image sensor, a presence sensor, a sound sensor, an infrared sensor and a temperature sensor.

8. The control device according to claim 7, wherein at least one sensor is an image sensor, the classification module being configured to classify the passenger by determining a height of the passenger from image(s) coming from the image sensor.

9. The control device according to claim 8, wherein the image sensor is a stereoscopic image sensor.

10. The control device according to claim 8, wherein at least one sensor is a sound sensor, the classification module being configured to identify a language spoken by at least one passenger, the generating module being configured to send the passenger service equipment item a command to transmit information to the passenger in the identified language.

11. A motor vehicle, the motor vehicle including a passenger compartment able to receive at least one passenger and at least one service equipment item for the passenger(s) received in the passenger compartment, the motor vehicle including a control device according to claim 1, the control device being coupled to each passenger service equipment item.

12. The motor vehicle according to claim 11, wherein the motor vehicle is an autonomous vehicle.

13. The motor vehicle according to claim 12, wherein the passenger service equipment item is chosen from the group consisting of:
an equipment item for regulating the temperature of the passenger compartment,
a display device,
an acoustic device,
a seat,
a door of the passenger compartment,
a smell generating device,
a control member able to be actuated by a passenger,
a window of the passenger compartment, and
a power outlet,

14. A control method of a motor vehicle, the motor vehicle including a passenger compartment able to receive at least one passenger, at least one service equipment item for the passenger(s) of the passenger compartment and a control device including an electronic detection module, an electronic classification module and an electronic generating module, the method comprising the following steps:
detecting at least one passenger of the passenger compartment via the detection module,
classifying the detected passenger in at least one passenger category, in particular among a set of predetermined passenger categories, via the classification module,
generating, via the generating module, a command of the passenger service equipment item, as a function at least of the identified passenger category, and
sending the command to the passenger service equipment item by the generating module.

15. The control method according to claim 14, wherein the vehicle is an autonomous motor vehicle.

16. A computer program comprising software instructions which, when executed by a computer, carry out a method according to claim 15.
